(19) United States
(12) Patent Application Publication
(10) Pub. No.: US 2012/0226587 A1
(43) Pub. Date: Sep. 6, 2012

(54) SYSTEM AND METHOD FOR ELECTRONICALLY-FACILITATED COLLECTIVE PURCHASING

(76) Inventor: Bernardo Perez de Lara, Boca Raton, FL (US)

(21) Appl. No.: 13/037,954

(22) Filed: Mar. 1, 2011

(51) Int. Cl. G06Q 30/00

(52) U.S. Cl. 705/27.1; 705/26.1

(57) ABSTRACT

A system for aggregating resources for the purchase of at least one item by a plurality of individual participants includes a server accessible over a network or Internet, an administrator terminal operable to communicate with the server and allow an administrator to enter and transmit to the server, a purchasing scenario for at least one item, the purchasing scenario specifying at least a group membership condition, an identifier of a recipient, and a purchasing goal, web pages operable to display to a plurality of invitees satisfying the group membership condition the identifier of the recipient and at least one of the purchasing scenario and the purchasing goal, and a plurality of individual participant terminals operable to display the web pages, communicate with the server, and allow the plurality of invitees to indicate to the server a participation in the purchasing scenario, whereby the server is operable to calculate a purchasing threshold defined by the purchasing goal to determine whether the plurality of invitees has reached the threshold by collectively indicating a willingness to reach the purchasing goal.

### FIELD OF THE INVENTION

The present invention relates generally to collective purchasing, and more particularly relates to a system and method of facilitating collective purchasing through an electronic network by a group.

### BACKGROUND OF THE INVENTION

The act of gift-giving goes back certainly to the beginning of, and most likely predates, recorded history. The giving of a gift is not only intended to fulfill the need of the recipient, but also fulfills the needs of the giver. When one gives a gift, they are hopefully filling a perceived need of the recipient while, at the same time, communicating to the recipient certain feelings, whether they be congratulatory, appreciative, gratuitous, sympathetic, fondness, humorous, generous, or one of many others.

Many gift-giving occasions occur, which include, among many others, birthdays, graduations, engagements, weddings, babies, anniversaries, promotions, retirements, holidays, and even bad turns or events, such as the loss of a job or loved one. During these occasions, a particular recipient, for example, a person graduating college, will receive a gift from each one of a group of people. Each of these gifts will be limited in cost by the particular budget of the member giving the gift. For example, each member of a 10-person group may only be able to or willing to afford a $50 gift. As a result, the recipient will receive 10 separate $50 gifts, each of which the recipient most likely could have purchased himself. In the end, no long-felt need of the recipient is fulfilled.

In the past, groups of gift-givers have organized and combined their money in an effort to purchase a gift that exceeds the gift-giving budget of any single member of the group. For example, in the immediately-preceding example, the group of gift givers could have presented the recipient with a single $500 gift rather than the 10 separate $50 gifts. This increased buying power can result in a substantially more fulfilled recipient. For example, if an individual is having a birthday and it is known that that person's refrigerator is broken beyond repair and needs to be replaced, the group's purchase of a new refrigerator will be tremendously more fulfilling to the recipient than a series of gifts that do not help him satisfy his basic need for fresh food.

Collective purchasing, such as that just described, is well known. However, facilitation of collective purchasing, using currently-known methods, is difficult and taxing on at least one member of the group. More specifically, to accomplish collective purchasing, there needs to be communication amongst members of the group either in a single group conversation or through multiple conversations with one or more subsets of the group. If a change in the direction (the purchasing goal) of the group takes place, re-coordination is difficult. For example, if the selected item suddenly becomes unavailable, how is the replacement item determined without at least a reconvening of the entire group or the participation of all group members in a series of hard-to-coordinate separate conversations?

There also must be at least one member in charge of collecting and using the funds received from each contributor. This disadvantageously makes that member responsible for a large sum of money solely to that member's detriment if the money is lost or stolen. In some cases, this member may also have to finance the purchase expecting to be paid by the other members. In other words, the responsible member bears responsibility with no reward. In addition, the responsible member must dedicate time and effort actually purchasing the item.

Furthermore, determining the item can bring with it a host of problems if, for instance, the group is not unanimous on the item, the financial goal necessary to purchase the item is not met, the item is difficult to locate or not available, and many others. Ultimately, difficulty in coordination and the reluctance of any single member being the responsible member prevents collective purchasing from taking place with any regularity.

In addition, in these prior-art fund-pooling methods, a contributor has no incentive to contribute an amount more than anyone else in the group, as the recipient will not know how the funds were proportioned during collection unless the coordinating member informs them of this, which they cannot rely on. The result is an incentive to contribute the minimal amount possible.

Therefore, a need exists to overcome the problems with the prior art as discussed above.

### SUMMARY OF THE INVENTION

The invention provides a system and method for electronically-facilitated collective purchasing that overcomes the hereinafore-mentioned disadvantages of the heretofore-known systems and methods of this general type and that allows multiple users to collaborate and pool funds for the purpose of providing one or more items to a recipient.

With the foregoing and other objects in view, there is provided, in accordance with the invention, a system for aggregating resources for the purchase of at least one item by a plurality of individual participants, which includes a server accessible over a network or Internet, an administrator terminal operable to communicate with the server and allow an administrator to enter and transmit to the server, and a purchasing scenario for at least one item, the purchasing scenario specifying at least a group membership condition, an identifier of a recipient, and a purchasing goal. Web pages are operable to display to a plurality of invitees satisfying the group membership condition the identifier of the recipient and the purchasing scenario and/or the purchasing goal. A plurality of individual participant terminals are operable to display the web pages, communicate with the server, and allow the plurality of invitees to indicate to the server a participation in the purchasing scenario, whereby the server is operable to calculate a purchasing threshold defined by the purchasing goal to determine whether the plurality of invitees has reached the threshold by collectively indicating a willingness to reach the purchasing goal.

In accordance with a further feature of the present invention, the server is operable to carry out the purchasing goal without a need for further participation by the administrator.

In accordance with a further feature of the present invention, the purchasing scenario includes a specified and limited time period and the server is operable to consider reaching the purchasing goal during the specified and limited time period a condition for the determining whether the plurality of invitees has reached the purchasing threshold.

In accordance with yet another feature of the present invention, the web pages are operable to display to the plurality of invitees satisfying the group membership condition an indicator of progress toward reaching the purchasing goal.

In accordance with an additional feature of the present invention, the at least one item is at least two items, the plurality of individual participant terminals are operable to transmit item-selection votes from the plurality of invitees to the server, and the server is operable to select a one of the at least two items based on a number of the item-selection votes received from the plurality of individual participant terminals.

In accordance with a supplementary feature of the present invention, the item-selection votes are weighted in proportion to an invitee's amount of participation in the purchasing scenario and/or an invitee's time of participation in the purchasing goal relative to other invitee's time of participation in the purchasing goal.

In accordance with an added feature of the present invention, the plurality of individual participant terminals are further operable to allow at least one invitee (which includes participants) within the plurality of invitees to alter the group membership condition.

In accordance with another feature, an embodiment of the present invention includes a computer implemented collective purchasing method stored on a server and accessible over a network or Internet, where the method includes a first step of generating a purchasing scenario implemented on the server, the purchasing scenario including at least a group membership condition, a purchasing goal, and an identifier of a recipient, wherein the purchasing goal is associated with at least one item intended for the recipient. The method further includes the steps of pooling a number of participations in the purchasing goal on the server over a period of time from a plurality of invitees satisfying the group membership condition, wherein the number of participations provides a collective commitment to contribute to a purchase of the item and consummating the purchasing goal on the server if the number of participations in the purchasing goal reaches a purchasing threshold defined by the purchasing scenario.

In accordance with the present invention, the consummating step includes completing a transaction to purchase the item and can be done without user participation.

Although the invention is illustrated and described herein as embodied in a system and method for electronically-facilitated collective purchasing, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

The terms “program,” “software application,” and the like as used herein, are defined as a sequence of instructions designed for execution on a computer system. A “program,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 illustrates a distributed data processing system in accordance with an embodiment of the present invention.

FIG. 2 is a block diagram of a data processing system that may be implemented as a network device, such as a server or terminal shown in FIG. 1, in accordance with an embodiment of the present invention.

FIG. 3 is a process flow diagram showing a method of defining a purchasing scenario in a gift space in accordance with an embodiment of the present invention.

FIG. 4 is a process flow diagram showing a method of participating in a purchasing scenario in a gift space in accordance with an embodiment of the present invention.

FIG. 5 is a process flow diagram showing a method of participating in a purchasing scenario in a gift space in accordance with an embodiment of the present invention.

FIG. 6 is a process flow diagram showing a method of carrying out a purchasing scenario in a gift space in accordance with an embodiment of the present invention.

FIG. 7 is an exemplary screen shot of a web page operable for joining a collaborative gift space and participating in a purchasing scenario in accordance with an embodiment of the present invention.

FIG. 8 is an exemplary screen shot of a web page operable for joining a collaborative gift space and participating in a purchasing scenario in accordance with an embodiment of the present invention.

FIG. 9 is an exemplary screen shot of a web page operable for joining a collaborative gift space and participating in a purchasing scenario in accordance with an embodiment of the present invention.

FIG. 10 is an exemplary screen shot of a web page operable for creating a purchasing scenario in accordance with an embodiment of the present invention.

FIG. 11 is an exemplary screen shot of a web page operable for creating a purchasing scenario in accordance with an embodiment of the present invention.

FIG. 12 is an exemplary screen shot of a web page showing information pertaining to a purchasing scenario in accordance with an embodiment of the present invention.

FIG. 13 is an exemplary screen shot of a web page dashboard showing information pertaining to a purchasing scenario in accordance with an embodiment of the present invention.

FIG. 14 is an exemplary screen shot of a web page operable for joining a collaborative gift space and participating in a purchasing scenario in accordance with an embodiment of the present invention.

FIG. 15 is an exemplary screen shot of a web page showing information pertaining to a purchasing scenario in accordance with an embodiment of the present invention.

FIG. 16 is an exemplary screen shot of a web page with two dashboards showing information pertaining to two purchasing scenarios in accordance with an embodiment of the present invention.

FIG. 17 is an exemplary screen shot of a web page dashboard showing information pertaining to a purchasing scenario and pending invitations in accordance with an embodiment of the present invention.

FIG. 18 is an exemplary screen shot of a web page operable for joining a collaborative gift space and participating in a purchasing scenario in accordance with an embodiment of the present invention.

FIG. 19 is an exemplary screen shot of a web page showing that a user, John, can simultaneously be an administrator and a participant in accordance with an embodiment of the present invention.

FIG. 20 is an exemplary screen shot of a web page showing that, after acceptance, John is a participant in a purchasing scenario for a second user in accordance with an embodiment of the present invention.

FIG. 21 is an exemplary screen shot of a web page operable for assigning voting weight among a plurality of potential gift items.

FIG. 22 is an exemplary screen shot of a web page showing an expressed distribution of voting weight among the plurality of potential gift items of FIG. 19.

FIG. 23 is a process flow diagram showing a method of automatically determining subject matter for potential purchasing scenarios in a gift space in accordance with an embodiment of the present invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

The present invention provides a novel and efficient system and method that facilitates aggregating resources for the purchase of at least one item for the benefit of a recipient by a plurality of individual buyers. Embodiments of the invention provide a networked system of terminals accessible and operable by each member within a group of users for the goal of pooling funds to acquire gifts for an individual, group of individuals, or an organization. In addition, embodiments of the invention provide simple management of the pool of funds, accountability for the donations, selection of the gift, and delivery and presentation of the gift to the recipient.

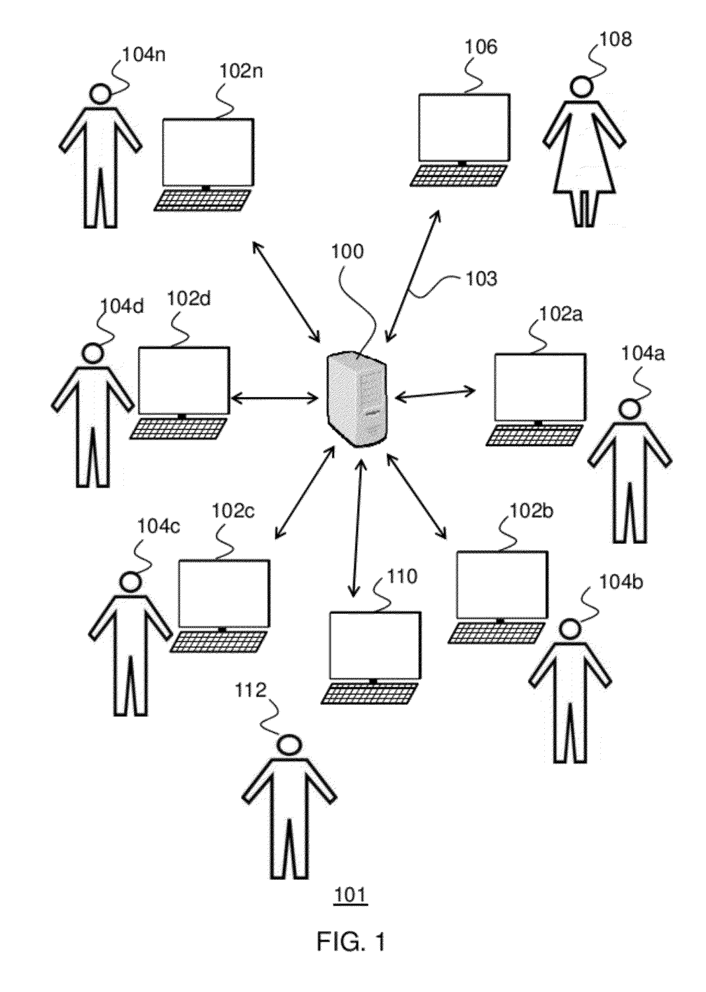

Referring now to FIG. 1, one embodiment of the present invention is shown in a diagrammatic schematic view. FIG. 1 shows several advantageous features of the present invention, but, as will be described below, the invention can be provided in several shapes, sizes, combinations of features and components, and varying numbers and functions of the components. The first example of a system 101 for aggregating resources for the purchase of at least one item by a plurality of individual participants, as shown in FIG. 1, includes a server 100 communicatively connected to an administrator terminal 106, a plurality of participant terminals 102, and a recipient terminal 110. Although the server 100 is shown as a single device and describes as “‘a’ server,” the server 100 can be many devices, such as a server farm. An administrator 108 communicates with the server 100 via the administrator terminal 106. The participant terminals, which are designated 102a to 102n, represent any number of terminals, and are collectively referred to as participant terminals 102. Invitees/participants 104 communicate with the server 100 via the participant terminals 102. The invitees/participants 104, which are designated 104a to 104n, represent any number of users of the present invention, and are collectively referred to as invitees/participants 104. There can be many invitees/participants 104; however, the actual numbers of invitees/participants 104 is not relevant so long as there are at least two invitees/participants 104 or at least one administrator 108 and one invitee/participant 104. A recipient 112 is the person for whom the collection is taking place. The recipient 112 can be one or more of the invitees/participants 104 or the administrator 108 and can contribute to his/her own item(s). The participant terminals 102 can be a single terminal used by one or more invitees/participants 104. Each device shown in FIG. 1 can play the role of all other devices shown in FIG. 1. For example, any one of the participant terminals 102 can be the administrator terminal 106 and/or the recipient terminal 110 and the administrator terminal 106 can be or serve as any one or all of the participant terminals 102 or recipient terminal 110.

Communication between the participant terminals 102, the recipient terminal 110, the administrator terminal 106, and the server 100 can be accomplished through any wired or wireless network 103, including the Internet, wireless local area network (WLAN), wireless personal area networks (WPANs), wireless metropolitan area networks (WMAN), wireless wide area networks (WWAN), a backbone network (BBN), a global area network (GAN), Cellular Data networks, Intranets and extranets, and many more.

In one embodiment, the participant terminals 102 and the administrator terminal 106 are connected to an ISP (Internet Service Provider) which provides access to the Internet Likewise the server 100 is connected to the internet via an ISP. The lines 103 in FIG. 1 therefore represent logical information flow and not necessarily physical connections.

As used herein, a terminal simply means any computing device that is capable of displaying information, receiving inputs, and communicating or recording the inputs. As used herein, an administrator terminal 106 simply means a terminal that receives inputs or displays information different from that received or displayed at a participant terminal 102, i.e., the administrator 108 operating the administrator terminal 106 has expanded capabilities/responsibilities. In other words, no hardware differences are needed between a participant terminal 102 and an administrator terminal 106. The sever 100 and the participant terminals 102 and/or the administrator terminal 106 can be the same device. Examples of terminal devices 102, 106 and/or servers 100 are computers, laptops, smart phones, thin-clients, tablets, WebTVs, Interactive TVs, PDAs, Information Appliances, or any other device that can be used by invitees/participants 104 and an administrator 108 to access the server 100 over a network, so the invitees/participants 104 can engage in a collaborative purchase.

The server 100 is one or more conventional network servers running software to keep track of a purchasing scenario, which will be described below, and create and cause to be displayed one or more web pages on a connected participant terminal 102.

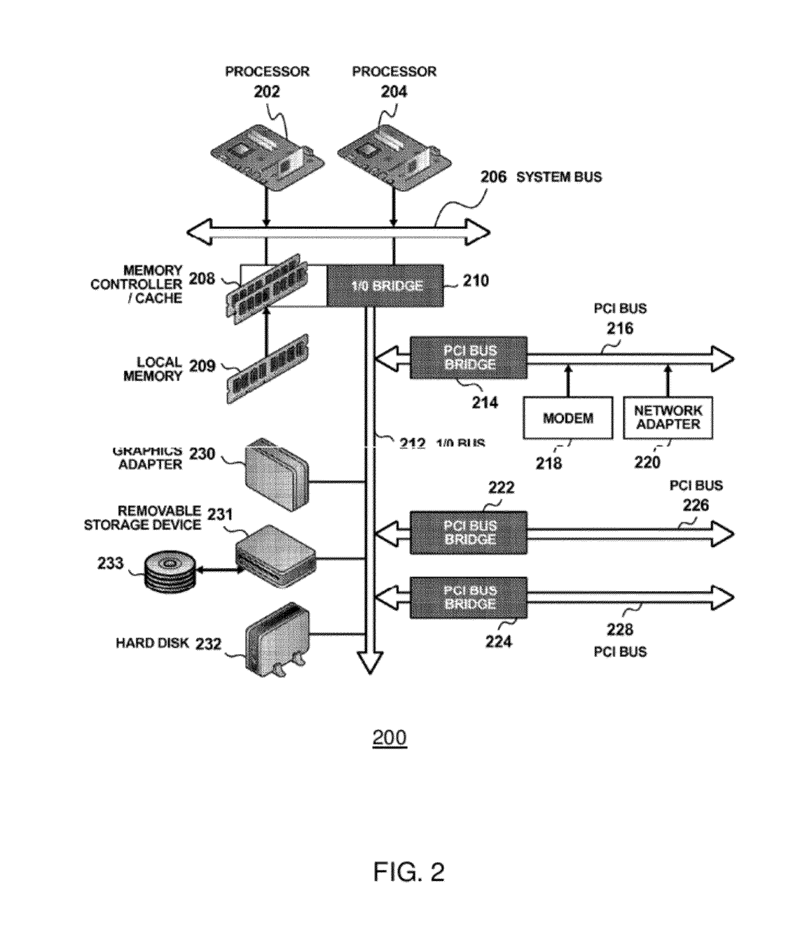

Referring to FIG. 2, a block diagram of a data processing system that may be implemented as a server, such as server 100 or implemented as a personal computer, such as terminal 102 or terminal 106 in FIG. 1, is depicted in accordance with one embodiment of the present invention. Data processing system 200 may be a symmetric multiprocessor (SMP) system including a plurality of processors 202 and 204 connected to system bus 206. Alternatively, a single processor system may be employed. Also, connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted. The processor 202 or 204 in conjunction with memory controller 208 controls what data is stored in memory 209. The processor 202 and/or 204 and memory controller 208 can serve as a data counter for counting the rate of data flow to the memory 209 or from the memory 209 and can also count the total volume of data accessed to or from the memory 209. The processor 202 or 204 can also work in conjunction with any other memory device or storage location.

Peripheral component interconnect (PCI) bus bridge 214 connected to I/O bus 212 provides an interface to PCI local bus 216. A number of modems or network communication connections may be connected to PCI bus 216. Typical PCI bus implementations will support four PCI expansion slots or add-in connectors. Communications links to network computers in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The collaborative gift space, including the purchasing scenario, which are both explained in detail below, can be embodied in a computer program. Computer programs (also called computer control logic) are stored in memory such as main memory 209, removable storage drive 231, removable media 233, hard disk 232, and signals. Computer programs may also be received via communications interface 216. Such computer programs, when executed, enable the computer system to perform the features of the present invention as discussed herein. In particular, the computer programs, when executed, enable the processor 202 and/or 204 to facilitate the functions for aggregating resources for the purchase of at least one item by a plurality of individual buyers within a collaborative gift space.

In this document, the terms “computer program medium,” “computer usable medium,” and “computer readable medium” are used to generally refer to media such as main memory 209, removable storage drive 231, removable media 233, hard disk 232, and signals. These computer program products are means for providing software to the computer system. The computer readable medium allows the computer system to read data, instructions, messages or message packets, and other computer readable information from the computer readable medium. The computer readable medium, for example, may include non-volatile memory, such as Floppy, ROM, Flash memory, Disk drive memory, CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network, that allows a computer to read such computer readable information.

Administrator

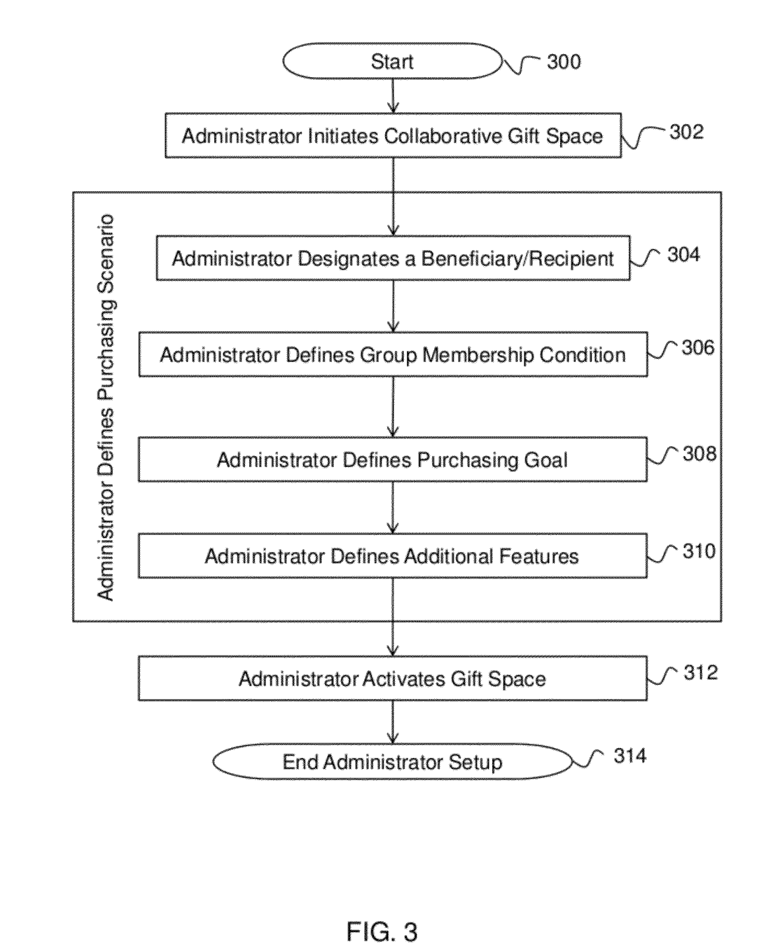

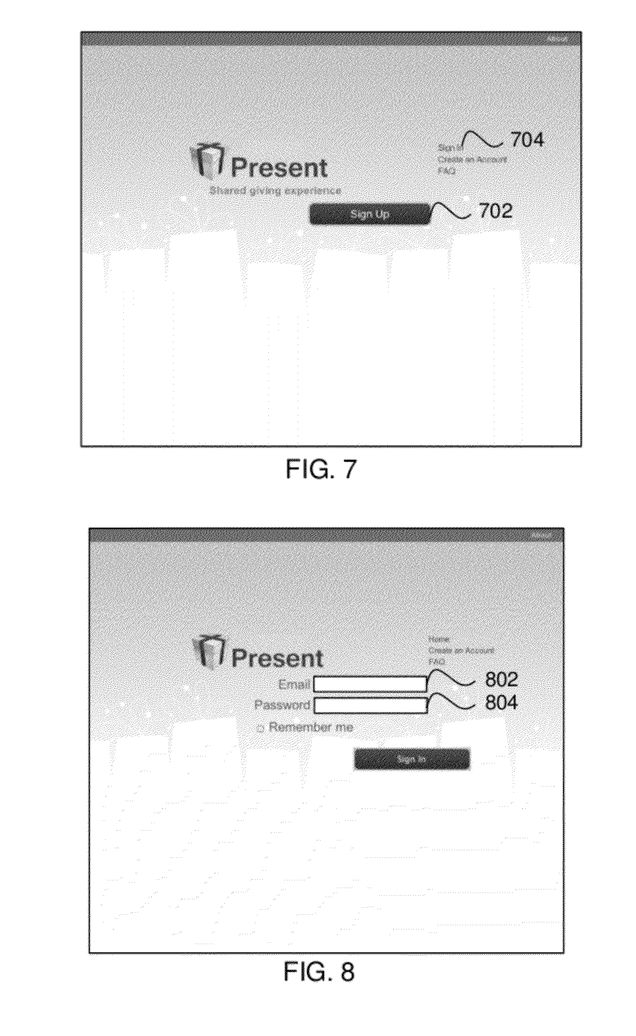

FIG. 3 provides a process flow diagram illustrating a first embodiment of the present invention and illustrates activities performed by an administrator 108. The flow of FIG. 3 starts at step 300 and moves directly to step 302, where an administrator 108, through an administrator terminal 106, accesses the server 100 to begin creating a collaborative gift space, e.g., a website/webpage for a beneficiary. One exemplary website/webpage 700 is shown in FIG. 7. By utilizing a network, which is communicatively coupled to participant terminals 102 and accessible by invitees/participants 104 designated by the administrator 108, the invitees/participants 104 are able access and participate in the collaborative gift space from disparate locations and at various times suitable to the invitees/participants 104.

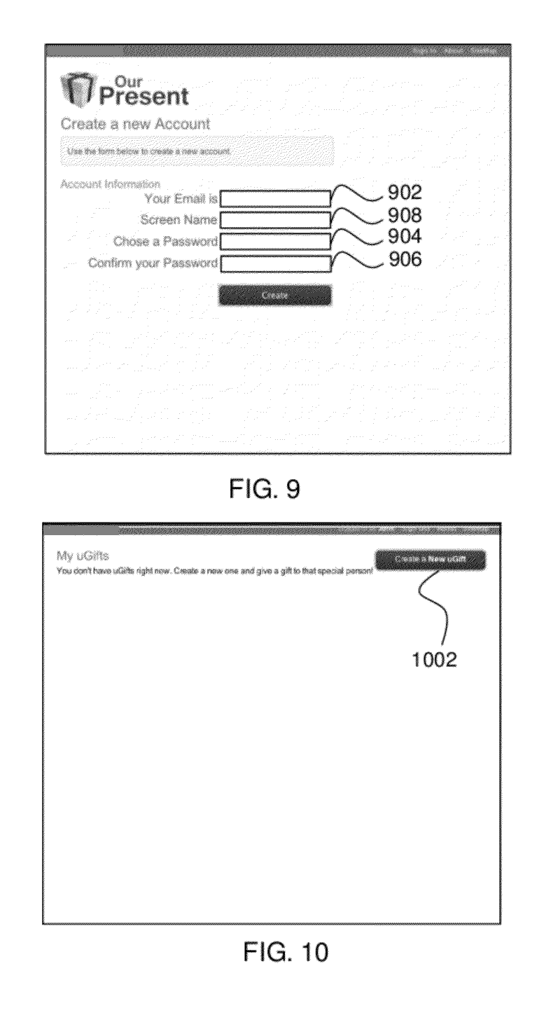

Step 302 includes the sub-steps shown in FIGS. 7-9 of selecting to sign up, e.g., by selecting button 702, or signing in, by selecting button 704. If the selection was to sign in, the administrator 108 is asked to enter a name or email in box 802 and a password in box 804 of FIG. 8. If the selection on FIG. 7 was to sign up, button 702, the administrator 108 is then asked to define an administrator name in box 902, a password in boxes 904 and 906, and to enter their desired screen/user name in box 908, all shown in FIG. 9.

An administrator, as used herein, means one or more members of a group that facilitate the setting up of the collaborative gift space and/or helping consummate the purchase and/or delivery of an item to a beneficiary. The administrator 108 can also be one of the invitees/participants 104 or even the recipient 112 of the gift item.

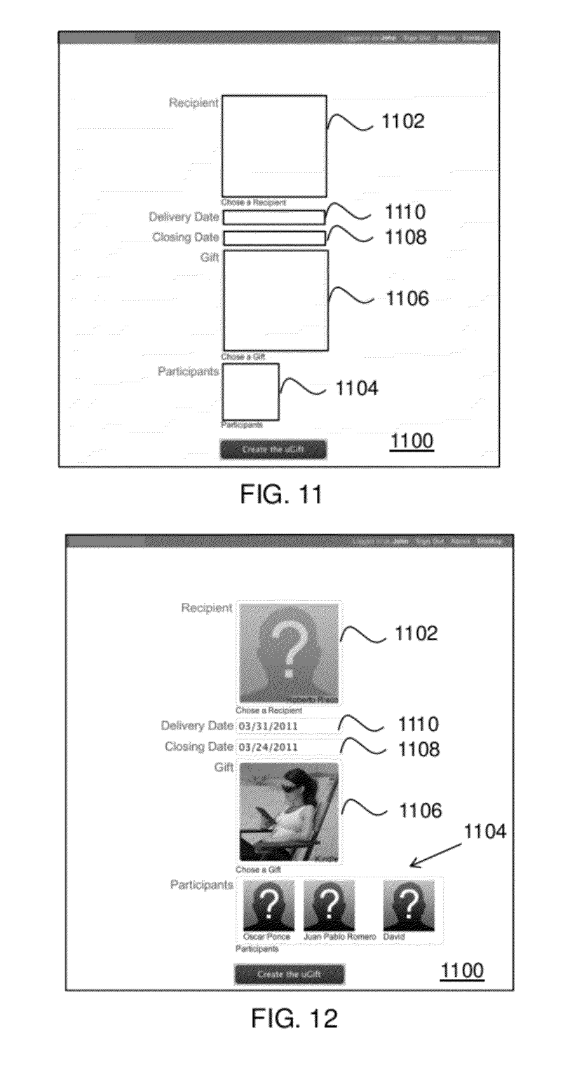

Next, the administrator 108 begins, e.g., by selecting button 1002 in FIG. 10, to define a purchasing scenario which will ultimately be shared with and participated in by the invitees/participants 104. The process of defining the purchasing scenario includes a first step 304 where the administrator 108 designates a beneficiary/recipient 112 by filling in field 1102 of FIG. 11. The beneficiary/recipient 112, referred to simply as a “recipient” hereafter, can be any person, e.g., a family member, a group of individuals, e.g., a football team, an organization, e.g., an office staff, or any other person or thing. If the recipient 112 already has an account, he/she/it can be identified by an account name, otherwise it can be identified by her email address, social network site name, or other. If the administrator 108 cannot find an active account on the server 100 for the recipient 112, she may create a “place holder” account on the server 100 for the recipient 112. When the recipient first connects to the server 100 through the recipient terminal 110, the place holder account can be migrated to an active account on the server 100.

Next, in step 306, the administrator 108 defines a group membership condition. This can be accomplished by populating field 1104 in FIG. 11 and the condition defines who is a member, i.e., an invitee/participant 104, of the initial list of invitees/participants 104 and who can be added to the initial list of invitees/participants 104. More specifically, the invitees/participants 104 can be a closed list that is limited to those defined in field 1104 during the administrator's initial defining in step 306 of the purchasing scenario or can be added to it only by the administrator 108 at a later time. In the open group scenario, the invitees/participants 104 are granted the ability to invite others to become invitees/participants 104 and share in the pooling of resources for the purpose of purchasing an item(s) for the beneficiary. In the open group scenario, the permission of the administrator 108 is not required to add additional invitees/participants 104. An invitee becomes a participant when she makes a contribution or commitment to contribute to the gift. The administrator 108 has the option to remove an invitee from the group membership condition, but, in one embodiment, cannot remove a participant.

Once the group membership condition is defined, the process moves to step 308 where the administrator 108 defines a purchasing goal. The purchasing goal includes at least one item, which can be defined in field 1106 of FIG. 11. The term “item,” as used herein, means a product, a service, or currency. “Currency” includes cash, electronic transfers of money, representations of currency, e.g., gift cards, and others. Generally, the item will be a gift(s) that falls within given parameters, such as the type of gift appropriate for the intended recipient 112 and/or the expected amount of money the group (invitees/participants 104) will contribute.

The selected item may be, but is in no way limited to, a single gift (including a cash dispersion embodied in a VISA gift card), a set of gifts, such as the ones selected by an engaged couple for registry, and a set of potential gifts, where one or more can be selected by the contributors or the recipient 112. The selection of the gift item can be based on an anticipated amount of the funds to be received, along with votes from the invitees/participants 104. The delivery/pick up address, which is used to calculate the shipping costs, may factor into the determination of the item, as it requires a portion of the collected funds.

With participant voting as a way of selecting a gift item, there are at least two options: 1. each vote will be equal regardless of the donation amount each invitee/participant 104 contributes; and 2. each invitee/participant's 104 vote is assigned a weight proportional to the amount that invitee/participant 104 contributed. In yet another embodiment, greater voting weight is assigned to the early contributors, i.e., more points are allocated as a bonus for early participation, which encourages the invitees/participants 104 to contribute quickly after receiving an invitation to do so. In other words, an invitee's time of participation, relative to other contributors and/or the time the purchasing scenario was shared with invitees/participants 104, determines the weight assigned to a particular vote.

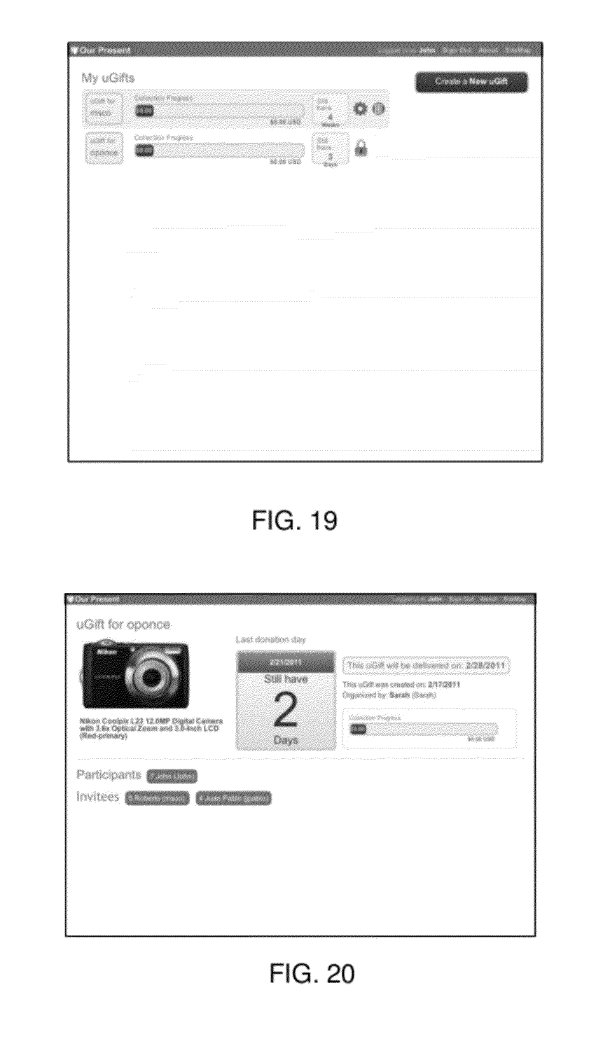

Alternatively, the recipient 112 of the item may be allowed to select from a choice of items, as shown in FIGS. 19 and 20. In this case, the administrator 108 grants permission to the recipient 112 to enter the collaborative gift space and review the gift options available and possibly the names of the invitees/participants 104.

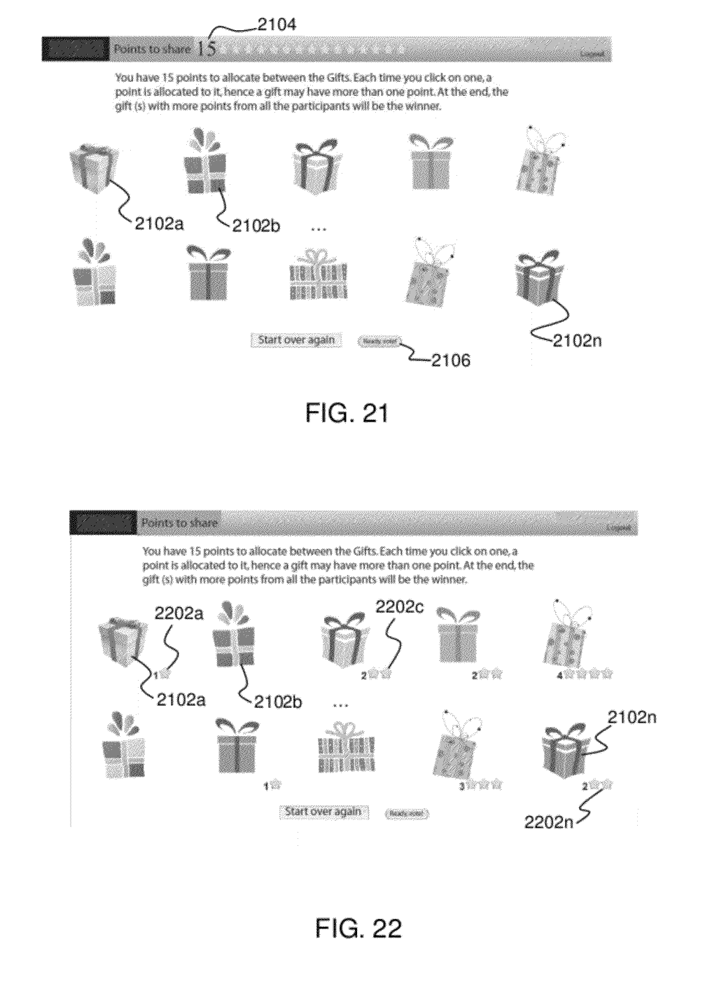

FIGS. 21 and 22 provide a graphical example of a way for invitees/participants 104 to vote, according to one embodiment of the present invention. As shown in FIG. 21, a selection of item choices 2102a-n, where n is any number greater than a, are shown on the screen. According to this embodiment, an invitee/participant 104 is able to allocate a specific number of votes/points 2104 amongst the selection of item choices 2102a-n. These votes/points can be earned or awarded in any of the ways described herein. When the invitees/participants 104 are finished voting, they can submit the votes by selecting a vote button 2106. As FIG. 20 shows, indicators 2202a-n indicate the number of votes allocated to each corresponding item 2102a-n.

The purchasing scenario can also include a specified and limited time period, i.e., contribution period, which can be defined by filling in field 1108 of FIG. 11. For example, if the gift is for a birthday, the time period should end prior to or on the recipient's birthday. A delivery time/date, which can be defined in field 1110, may factor into the determination of this specified and limited time period for collecting donations. The inventive system may consider reaching the purchasing goal during the specified and limited time period a condition for determining whether the plurality of invitees has reached the purchasing threshold. In this case, the specified and limited time period may be well before the intended delivery date so that if the purchasing goal isn't met, a backup purchasing scenario may be followed, e.g. return of everyone's contribution for purchases of individual gifts, purchase of a less expensive item than originally intended, defining a new group membership, and others.

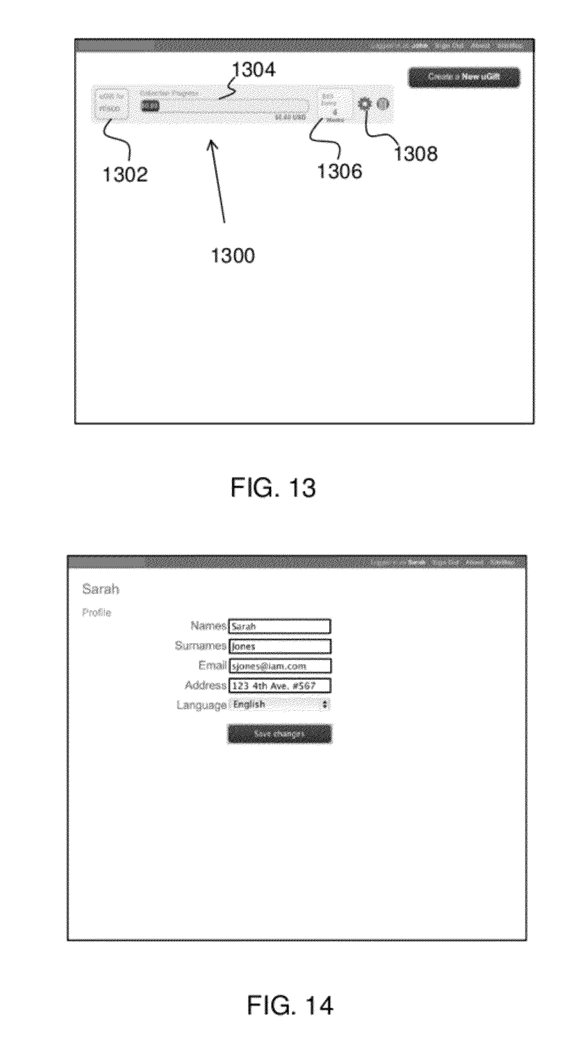

FIG. 12 provides an exemplary screen shot of the purchasing scenario 1100 at least partially complete, with each of fields 1102-1110 complete. FIG. 13 shows an exemplary screen shot illustrating a dashboard 1300 that indicates several properties of the purchasing scenario 1100. Namely, the recipient is identified in field 1302, the collection progress is shown in field 1304, and the time remaining in the specified and limited time period is indicated in field 1306. In addition, the dashboard 1300 features an indicator 1308 that indicated that the user has administrator privileges.

Now that the group membership condition, the identification of the recipient 112, and the purchasing goal are defined, the administrator 108 can, in step 310, define/activate additional features for the purchasing scenario. The features can include, but are not limited to, any of the following:
1. A contribution amount required to participate. This can be defined as open, a range, e.g., from $x to $y, or a fixed amount. If a fixed amount contribution is requested, then only $x is specified, i.e., $y would be equal to $x.
2. Contribution levels, such as platinum, gold, and silver, based on contribution amounts. The contribution levels can be displayed to the contributing invitee/participant 104, to all contributing invitees/participants 104, to the recipient of the item, or to a combination thereof.
3. A graphical depiction, e.g., field 1304 of FIG. 13, of the received or committed contributions. For example, a graphical depiction of a money box may be used to represent an escrow account where the funds or other types of contributions are accumulated during the collaborative collection process of the instant invention.
4. Gift options, which can be a selection of items promoted in the collaborative gift space, items from other web-sites, items from physical stores, services, or a cash distribution.
5. Indicators of progress in reaching the purchasing goal. For example, messages can be sent to the invitees/participants 104 to inform them of the progress in the collection of funds.
6. A gift note utility, where the invitees/participants 104 can leave comments, e.g., well wishes, condolences, and others for the recipient 112. In addition, the comments can be used to inform the recipient 112 that a gift is coming her way. Comments may be restricted to only contributing participants and not invitees who have refused or have not yet contributed.
7. A gift receipt acknowledgement utility, where the recipient 112 leaves a message for the invitees/participants 104 and/or the administrator 108 (who is usually one of the participants) indicating that she received the gift.
8. An administrator rating area that provides information pertaining to the administrator 108, such as identification, relationship to the recipient 112, relationship to the invitees/participants 104, feedback on the administrator's past performance as an administrator, and many more. This information can be sent with the invitations to the invitees/participants 104 to participate in the purchasing scenario. An administrator 108 with a bad reputation may not be allowed to set up a new purchasing scenario.

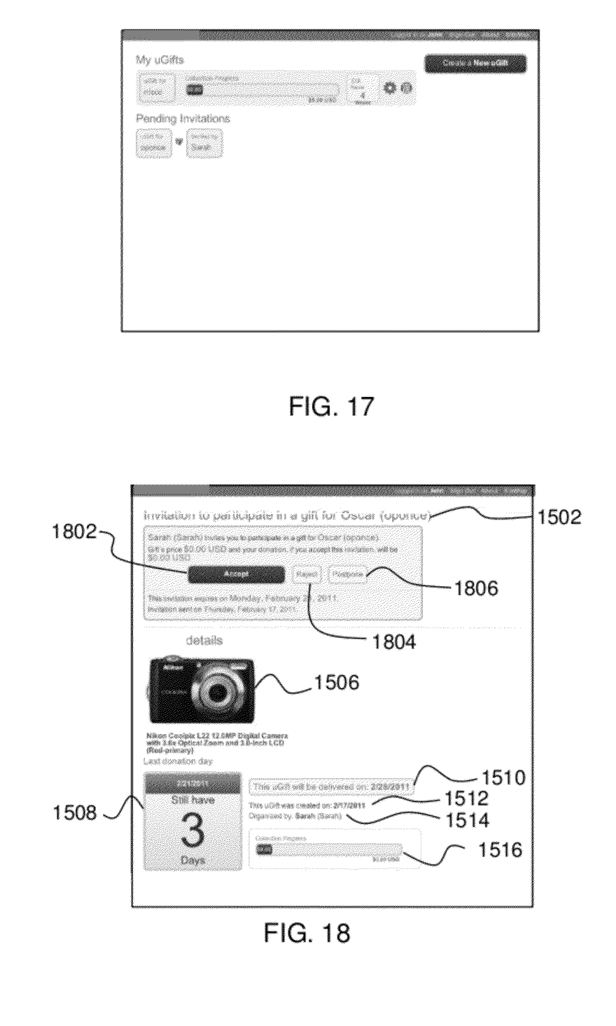

Once the collaborative gift space is defined, the administrator 108 shares it in step 312, e.g., grants the invitees/participants 108 meeting the group membership condition access to a webpage/website displaying the space. The process for administrator definition of the collaborative gift space ends at step 314. As is shown in FIG. 16, the present invention allows an administrator 108 to administrate multiple purchasing scenarios for multiple recipients and, as shown in FIG. 17, simultaneously participate in one or more other purchasing scenarios.

Invitee/Participant

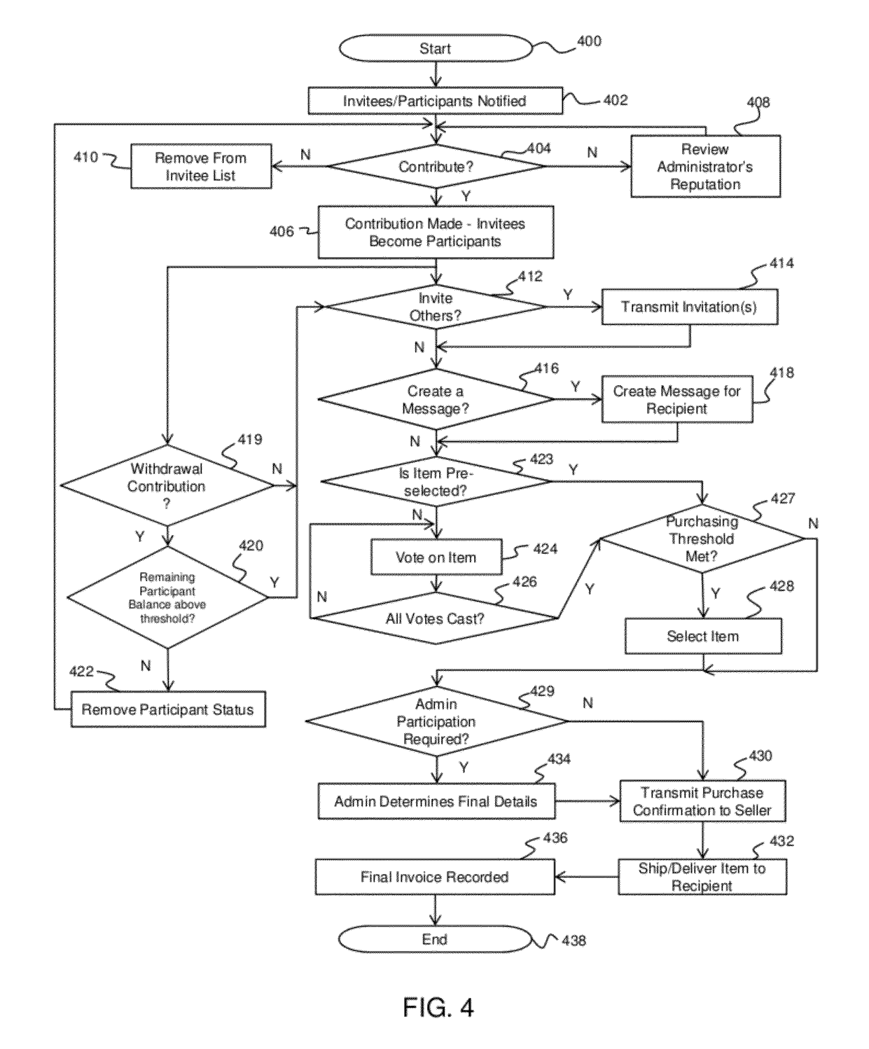

FIG. 4 provides a process flow diagram illustrating the presently-inventive process from the invitees/participants' 104 point of view. The flow of FIG. 4 starts at step 400 and moves directly to step 402 where the invitees/participants 104 receive notice that they are included within the membership condition. This notice can be delivered via email, web pages displayed on the invitee/participant terminals 102 for the invitees/participants 104 satisfying the group membership condition, or any other delivery method. The notice can include an identifier of the recipient 112, the purchasing scenario defined by the administrator 108, and/or the purchasing goal.

The invitees/participants 104 will be informed by the administrator 108 or, when dealing with an open membership condition, are invited by other invitees/participants 104. The invitees/participants 104 may receive the invitation to their email account, social networking account(s), via short messaging service (SMS), phone call, or directly on a preexisting account within the collaborative gift space service.

In step 404, the invitees/participants 104 decide whether to participate in the purchasing goal. The invitees/participants 104 may need to log in if they already have an account on the server 100 or can register as new users. As shown in FIG. 14, a user “Sarah Jones” is registering by including her personal information. It should be noted that Sarah can simultaneously be an invitee/participate 104 in one scenario and an administrator 108 in another. This situation is illustrated in FIG. 17, where a user, John, is an administrator for a recipient identified as “rrisco” and also has a pending invitation from Sarah to participate in a purchasing scenarios for a user indentified as “oponce.”

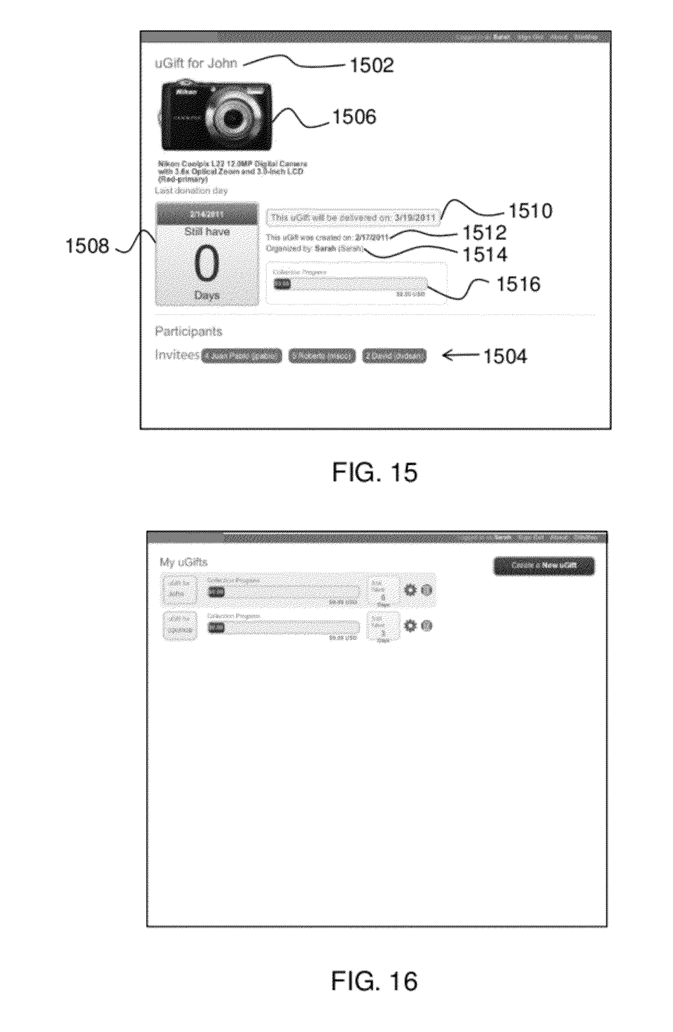

The administrator 108 can see all information pertaining to the collaborative gift space, which facilitates the purchasing scenario, and can specifically define what is shown to the invitees/participants 104. For instance, and as shown in FIGS. 15 and 18, information that may be made available to them at this point can include, but is not limited to, a field 1502 showing the name or identification of the intended recipient 112, a field 1504 showing a list of other invitees/participants 104 included in the membership condition (only shown in FIG. 15), a field 1506 showing the item, a field 1508 showing the time remaining in the specified and limited time frame, a field 1510 showing a delivery date, a field 1512 showing the creation date of the purchasing scenario, a field 1514 identifying the administrator, and field 1516 showing progress toward achieving the objective as reflected by deposits on the virtual money box, which can be shown in a graphical form, with or without showing the actual values. Additional aspects of the collaborative gift space that could be shown are a list of other invitees/participants 104 that have already contributed and the contribution made by each invitee/participant 104.

In addition, prior to or after the invitees/participants 104 join the collaborative gift space, the administrator can communicate messages to them showing items that can be purchased with the funds available in the money box. This selection can dynamically change as the pooled contributions increase. For example, the administrator 108 could have pre-defined a list of items with increasing cost, with one or more of them being automatically selected as fund contributions increase.

As shown in FIG. 18, the invitee/participant 104 can accept the invitation by clicking the accept button 1802. The invitee/participant 104 can also reject the invitation, button 1804, or postpone the invitation, button 1806. As FIG. 18 shows, additional information can be made available to the invitee/participant 104, such as the expiration date of the invitation, the date the invitation was sent, the price of the gift item, the invitee/participant's 104 minimum contribution amount, and many others.

Returning back to FIG. 4, if the decision of step 404 is to join, the flow moves to step 406, where the invitees'/participants' 104 status changes. An invitee becomes a participant when they create an account and/or make a contribution to the purchasing goal. In some cases, the clearance of the transaction is a prerequisite to this change in status. An invitee/participant 104 and administrator 108 can make a donation by any known means of transferring value, including PAYPAL, credit card, Electronic Funds Transfer (EFT), Bill Pay, e-check, Check by mail, or others.

In one embodiment of the present invention, before becoming a participant, an invitee can review the administrator's 108 information/reputation in step 408. If the invitees/participants 104 decide not to participate in the purchasing goal, i.e., do not make a donation or do not make a contribution that equals or exceeds a minimum contribution amount, they are subject to be removed by the administrator 108 from the group membership condition in step 410. For ease of understanding, the term invitees/participants 104 is used throughout the instant description to indicate either status.

Next, in steps 412 and 414, if the administrator defined the group membership condition as open, the invitees/participants 104 may alter the group membership condition by extending invitations to others to join the purchasing scenario. In steps 416 and 418, the invitees/participants 104 may wish to create a message that will be shared with the item recipient 112.

In accordance with one embodiment of the present invention, a particular invitee/participant 104 can request a contribution refund or all or a portion of their contribution in step 419. This option exists as long as the request takes place within the donation period, i.e., before the pooled funds are committed to the purchase of the item. As shown in steps 420 and 422, if, after the refund, the Participant's contribution is not enough to qualify her as a participant, her gift note will be removed and she will no longer have participant status.

In steps 423 and 424, if the item is one that can be selected by voting, the invitee/participant 104 may cast her vote for the item she thinks will be the best choice for the intended recipient 112. In step 426, the process waits for all votes/contributions to be received and, in step 428, an item is selected. Step 426 can include the expiration time of the specified and limited time period defined in the purchasing scenario. After all votes (and contributions) have been received, the flow moves to step 427 where a determination is made as to whether the purchasing threshold, i.e., the minimum combined contributions needed to obtain the selected item, have been collected. This purchasing threshold is defined in the purchasing goal, which is itself defined in the purchasing scenario, both, according to one embodiment of the present invention, being defined by the administrator 108. If the answer to step 427 is no, the process moves to step 429, where the administrator 108 determines how to proceed. This can include selection of a less expensive item, soliciting further contribution, adjusting the time for participant contributions, and more.

If the determination of step 427 is yes, the process moves to step 428 where an item is selected. This selection of step 428 can be automatically performed by the server 100 without further participation by the administrator 108, but can also include participation by the administrator 108. For example, the server 100 or the administrator terminal 106 can transmit a purchase instruction to a seller of the selected item in step 430 and, in step 432, the item is shipped directly from the seller to the recipient 112.

Alternatively, the administrator 108 can remain involved and, in steps 429 and 434, make further determinations, such as which item will be selected, the delivery location and time, and others. For example, the administrator 108 may choose for the item to be available for the administrator 108 to personally deliver directly to the recipient 112, for the item to be shipped to the recipient 112, to be picked up by the recipient 112 at a specific location, or any other delivery method.

In certain embodiments of the present invention, the administrator 108 remains responsible for the handling of the pooled funds. At the closing of the contribution period, the administrator 108 has access to these funds to purchase the gift for the recipient 112 and therefore all the other invitees/participants 104 need to trust that the administrator 108 is reliable with the entrusted contributions. As a measure of transparency, in step 436, the administrator 108 can record a copy of the invoice showing the purchased item or, alternatively, if the item is monetary, a bank deposit showing funds transferred to the appropriate location, e.g., the recipient's account. These invoices can be made available to all invitees/participants 104 to view. In step 438, the process ends. In an optional step, the invitees/participants 104 can be requested to rate the administrator's performance, which information can be used for establishing the administrator's reputation.

Recipient

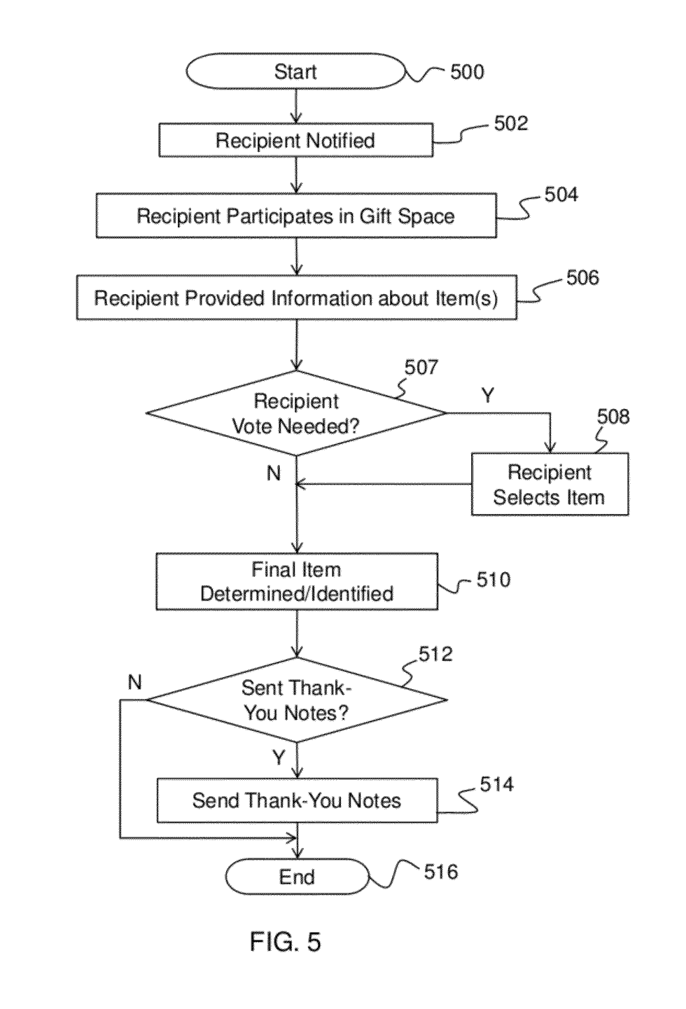

FIG. 5 provides and exemplary process flow diagram of a recipient's participation in the presently-inventive process facilitated by the novel system. As stated above, the recipient 112 may be an individual, an organization, or a set of individuals. The flow of FIG. 5 starts at step 500 and moves directly to step 502, where the recipient 112 is first made aware of the plurality of individual buyers' aggregation of resources in order to purchase the item for the recipient. The awareness can be realized in the form of a message sent, for instance, by email to the recipient 112. The message may include notification that the recipient can learn the details of an item selected for him/her or can select one or more from among a list of items viewable at the collaborative gift space, e.g., a website/webpage. The notification can include a link from where the recipient 112 can retrieve her gift note or notification that her gift will be delivered, including the package tracking number, if available. Alternatively, the notification of step 502 can include the address or location where the recipient 112 can pick-up her item, including information regarding all required documentation to be presented for pick-up and who contributed to the purchase of the item.

Depending on the type of purchasing scenario defined by the administrator 108, the recipient 112 may not learn about the purchasing scenario until the day that she receives the gift. Alternatively, the recipient 112 may be the administrator 108, as in a situation where the item is a gift registry for a wedding, for example, or the recipient 112 may have previously corresponded with the administrator 108 and already know about the item/purchasing scenario.

In step 504, the recipient 112 performs the necessary participation in the process. The participation can include, using the participant terminal 110 to create an account on or through the server 100 to authenticate the recipient 112 as the proper person. In step 506, the recipient 112 is informed of the details of the item(s) selected for or selectable by the recipient 112. If the administrator 108 selected the option 507 where the recipient 112 can select a gift from a set of potential gift items (which gift items can be acquired with the pooled contributions in an account for the recipient 112), then the recipient 112 may select her gift from that set in step 508. What is presented and how it is presented to the recipient 112 depends on how the administrator 108 configured the purchasing scenario. The recipient 112 may only see one or more selectable gift items, but not the balance in the money box. Alternatively, the recipient 112 may see the balance in the money box and be allowed to request a gift card, for example, VISA, based on the funds available in the money box. In step 510, the final item(s) is/are identified to the recipient 112 or determined from the recipient's vote in step 508.

In steps 512 and 514, the recipient 112 is provided the opportunity to create a thank-you/gift-acknowledgment message for one or more of the invitees/participants 104 and the administrator 108. This message can include a single thank-you message to all invitees/participants 104 indicating that she got the gift (and hopefully liked it) or individual thank-you messages to each invitee/participant 104 and/or the administrator 108. Alternatively, the recipient 112 can record a voice or video message that this transmitted or otherwise made available to the invitees/participants 104 to view.

As described above, the collaborative gift space is created when the administrator 108 defines it by setting the purchasing scenario. The collaborative gift space and, therefore, the purchasing scenario, is considered finished in step 516 when the thank-you/gift-acknowledgment message is sent by the recipient 112 or, alternatively, when the administrator 108 sends a gift acknowledgement on behalf of the recipient 112. This is useful when the recipient 112 is an organization or when the recipient 112 does not have Internet access.

Overall System

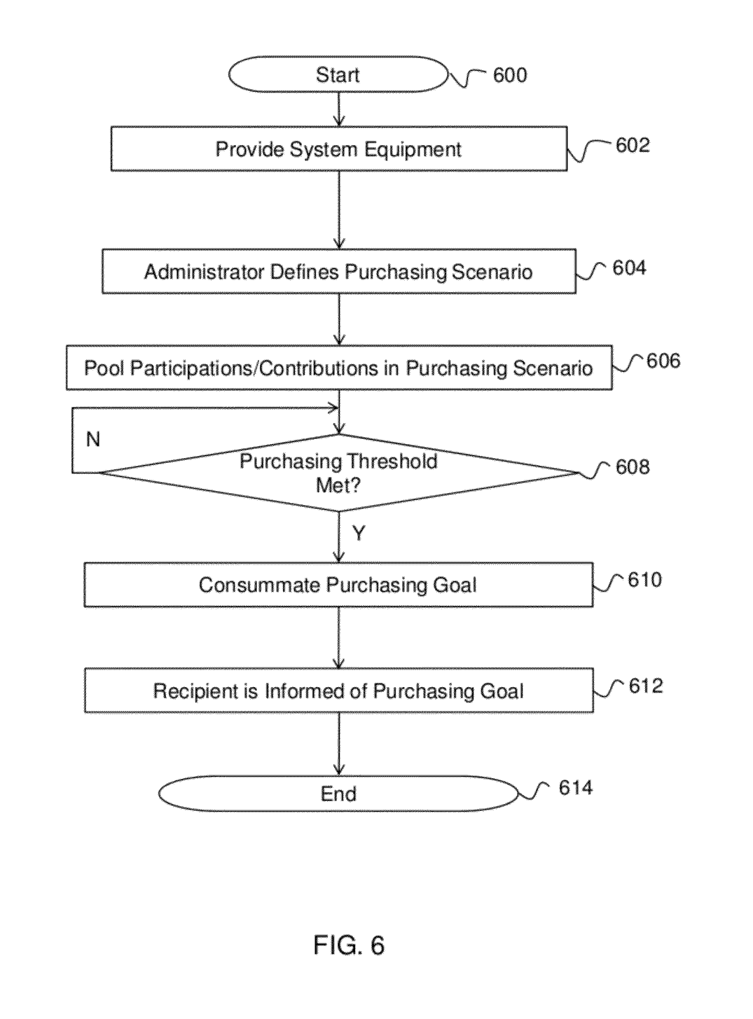

The following description in conjunction with the process flow chart of FIG. 6 shows one exemplary operational process in accordance with one embodiment of the present invention. It should be noted that the invention is not limited to the order of steps shown in any figure of the instant application or the steps described herein.

The flow of FIG. 6, which shows method for aggregating resources for the purchase of at least one item by a plurality of individual participants, starts at step 600 and moves directly to step 602. In step 602, there is provided, at least:
1. a server 100 accessible over a network or Internet 103;
2. an administrator terminal 106 operable to communicate with the server 100 and allow an administrator 108 to enter and transmit to the server 100, a purchasing scenario for at least one item, the purchasing scenario specifying at least a group membership condition, an identifier of a recipient 112, and a purchasing goal;
3. web pages operable to display to a plurality of invitees 104 satisfying the group membership condition the identifier of the recipient 112 and at least one of the purchasing scenario and the purchasing goal; and
4. a plurality of individual participant terminals 102 operable to display the web pages, communicate with the server 100, and allow the plurality of invitees 104 to indicate to the server 100 a participation in the purchasing scenario.

In step 604, the administrator 108 utilizes the administrator terminal 106 and the server 100 (which may both be the same device) to generate a purchasing scenario implemented on, i.e., accessible through or facilitated by the server. The purchasing scenario, according to one embodiment of the present invention, includes at least a group membership condition, a purchasing goal, and an identifier of a recipient 112, wherein the purchasing goal is associated with at least one item intended for the recipient 112.

In step 606, a number of participations in the purchasing goal are pooled (combined) on the server over a period of time from a plurality of invitees satisfying the group membership condition. The number of participations by the invitees provides a collective commitment to contribute to a purchase of the item. As used herein, the term “on the sever” means processing performed by the server or the server is used to communicate data to another device that performs the processing.

In step 608, the server 100 or some system device operating on or through the server calculates a purchasing threshold defined by the purchasing goal and determines whether the plurality of invitees 104 has reached the purchasing threshold by collectively indicating a willingness to reach the purchasing goal.

In step 610, the purchasing goal is consummated on the server if the number of participations in the purchasing goal reaches a purchasing threshold defined by the purchasing scenario. As used herein, the term “consummated” means considered finalized and/or a completed transaction to purchase the item. As used herein, the term “purchasing threshold” means a minimum amount of contribution needed to purchase a particular item(s) that was selected as the purchasing goal. In an embodiment of the present invention, the consummating step is carried out electronically without the need for further participation from the administrator 108.

In step 612, the recipient 112 is informed of the purchasing goal. This step can include receiving the selected item or participating in selecting the item. The process ends at step 614. In one embodiment, if the target item goes on sale, i.e., the price is reduced, the administrator may decide to purchase the item before all of the invitees 104 have participated or before the funds have reached the target level. Alternatively, the administrator may adjust the limited and specified time period and communicate this to the invitees/participants 104.

### EXAMPLES

The following provides a few examples of how features of the present invention can be utilized.

A. Birthday

The ladies in the tennis team have decided that, for the next teammate birthday, instead of each team member giving a personal gift, each teammate, excluding the birthday lady, will donate a fixed amount to a gift pool and with the funds accumulated they will select a present. The ladies in the tennis team utilize the present invention to collect the donations, write the gift note and select the gift for the birthday lady. This case also applies for the room mother who needs to collect funds for a teacher's gift.

B. Collection of Funds

Robert learns that his cousin John has lost his job and is struggling to pay his bills. Robert contacts other family members to see if they are willing to provide a donation to help John. Instead of Robert receiving the funds and having to manage them, he utilizes the present invention to collect the funds for John, allowing the family members to see who else has participated and also to write a gift note for John, who will have access to the funds at the end of the collection period. This case also applies when the Beneficiary is a non-profit organization or an emergency relief due to a natural disaster.

C. Purchase of an Item for Person in Need

Linda contacts her siblings to let them know that the washing machine is not working properly at their parent's home. She found a good replacement unit within the inventive gift space and requests a donation from her siblings to be able to acquire it. Even though her siblings are geographically diverse, i.e., located in different countries, utilizing different currency, they all have the same opportunity to make a donation and write a gift note.

D. Advanced Collection of Funds

Brian gets selected to organize a trip for the football game next month. He has to find the airline tickets, hotel, rental car and stadium tickets. Instead of paying up-front for all with his credit card, he is able to utilize the present invention to collect the funds from his friends, and once the funds are available, he makes the online purchases.

E. Free Registry

Similar to the concept of a Free House in the UK, which is a pub that is not tied to a brewery, the Free Registry enables engaged couples to select the gifts they want to receive from a variety of stores instead of being limited to a single store like with the traditional Registries. From the point of view of the people buying the gifts, the Free Registry capability of the present invention reduces the locations they need to visit to select the appropriate gift and also provides the option to see how their monetary gift is used to purchase the objects that the couple selects.

### CONCLUSION

A system and method has been disclosed, the system and method being used for electronically-facilitated collective purchasing of one or more items by two or more parties. With the present invention, it is possible create a pool of funds to acquire gifts for a person, family, organization, or others by requesting donations/contributions from one or more participants. Utilizing the present invention, the management of the pool of funds, the accountability for the donations/contributions, the selection of the gift, and the delivery and presentation of the gift to the beneficiary is greatly simplified and the overall giving experience is improved.

Individuals will be encouraged to proactively participate in embodiments of the present invention, such as setting up an account and selecting items, in expectation of someday becoming a recipient for a future occasion. By preregistering, they make it all that much easier for their friends and family to select them as a recipient some day. For this reason, the invention will be attractive to use by many individuals and organizations and, because of the advanced registration, it will be easy to utilized and include participants in any purchasing scenario.

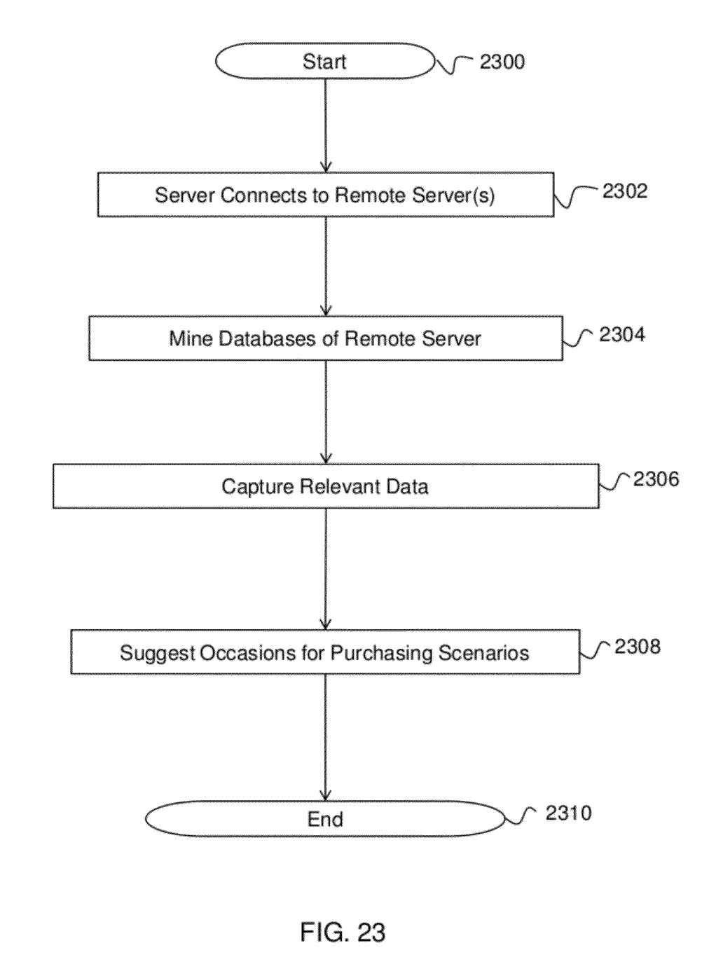

In some embodiments, the present invention is electronically linked to and communicates with one or more social networks, such as FACEBOOK, and is able to retrieve birth dates and other notable occasion information, e.g., determine communications indicative of a graduation or loss of a loved one, and, in one embodiment, link these determined events to friends, family, and coworkers of the potential recipient. In this way, the present invention can facilitate and even proactively inform, remind, and/or encourage any person to create/participate in a purchasing scenario for others through utilization of the present invention. By accessing an extensive “friend” list, such as that defined within and utilized by FACEBOOK, setting up a purchasing scenario and, in particular, identifying members and member information for inclusion in the membership condition, the ease and functionality of present invention can be increased even more. This process is illustrated in the process flow of FIG. 23.

The process of FIG. 23 starts at step 2300 and moves directly to step 2302 where the server 100 establishes a connection with a remote server(s) coupled to or storing databases associated with a social network, such as FACEBOOK, a professional network, such as LINKEDIN, or other networked utilities. In step 2304, the databases associated with the networks are “mined,” i.e., searched for relevant data associated with users. This can include logging on to the system and automatically searching user profile information. In one embodiment, the present invention is able to compare a database of registered users and/or previous users of the shared gift space to user information in one or more of the other network utilities. The invention can then establish connections between users, those persons that the users are connected to, and 3rd, 4th, and greater levels of connection between friends of friends. The present invention, in step 2306, can then capture relevant data from the databases, such as birthdays and anniversaries, just to name a few, and, in step 2308, suggest these occasions to the users of the shared gift space as item-giving occasions. The present invention can also suggest these occasions to persons that are not yet users of the shared gift space, through email messages or others obtained from mining the networks.

In yet a further embodiment of the present invention, invitees/participants are able to submit a “pledge,” or promise to contribute, when there is enough time before the delivery of the gift. The pledge aids the administrator on the budgeting of the gift by providing him or her with an idea of how much money will be collected.

What is claimed is:

1. A system for aggregating resources for the purchase of at least one item by a plurality of individual participants, the system comprising:
a server accessible over a network or Internet;
an administrator terminal operable to communicate with the server and allow an administrator to enter and transmit to the server, a purchasing scenario for at least one item, the purchasing scenario specifying at least a group membership condition, an identifier of a recipient, and a purchasing goal;
web pages operable to display to a plurality of invitees satisfying the group membership condition the identifier of the recipient and at least one of the purchasing scenario and the purchasing goal; and
a plurality of individual participant terminals operable to display the web pages, communicate with the server, and allow the plurality of invitees to indicate to the server a participation in the purchasing scenario,
whereby the server is operable to calculate a purchasing threshold defined by the purchasing goal to determine whether the plurality of invitees has reached the threshold by collectively indicating a willingness to reach the purchasing goal.

2. The system according to claim 1, wherein:
the server is further operable to carry out the purchasing goal without a need for further participation by the administrator.

3. The system according to claim 1, wherein:
the purchasing scenario further includes a specified and limited time period; and
the server is further operable to consider reaching the purchasing goal during the specified and limited time period a condition for the determining whether the plurality of invitees has reached the purchasing threshold.

4. The system according to claim 1, wherein:
the web pages are further operable to display to the plurality of invitees satisfying the group membership condition an indicator of progress toward reaching the purchasing goal.

5. The system according to claim 1, wherein:
the at least one item is at least two items;
the plurality of individual participant terminals are further operable to transmit item-selection votes from the plurality of invitees to the server; and
the server is further operable to select a one of the at least two items based on a number of the item-selection votes received from the plurality of individual participant terminals.

6. The system according to claim 5, wherein:
the item-selection votes are weighted in proportion to at least one of:
an invitee's amount of participation in the purchasing scenario; and
an invitee's time of participation in the purchasing goal relative to at least one other invitee's time of participation in the purchasing goal.

7. The system according to claim 1, wherein:
the plurality of individual participant terminals are further operable to allow at least one invitee within the plurality of invitees to alter the group membership condition.

8. The system according to claim 1, wherein:
the participation in the purchasing scenario is a contribution of money.

9. The system according to claim 8, wherein:
the purchasing scenario further includes a minimum participant contribution level.

10. The system according to claim 1, wherein:
the web pages are further operable to display to the plurality of invitees a level of the participation in the purchasing scenario for each invitee within the plurality of invitees.

11. A computer implemented collective purchasing method stored on a server and accessible over a network or Internet, the method comprising:
generating a purchasing scenario implemented on the server, the purchasing scenario including at least a group membership condition, a purchasing goal, and an identifier of a recipient, wherein the purchasing goal is associated with at least one item intended for the recipient;
pooling a number of participations in the purchasing goal on the server over a period of time from a plurality of invitees satisfying the group membership condition, wherein the number of participations provides a collective commitment to contribute to a purchase of the item; and
consummating the purchasing goal on the server if the number of participations in the purchasing goal reaches a purchasing threshold defined by the purchasing scenario.

12. The method according to claim 11, wherein:
the consummating step includes completing a transaction to purchase the item.

13. The method according to claim 11, wherein:
the consummating step is carried out without user participation.

14. The method according to claim 11, wherein:
the purchasing scenario further includes a specified and limited time period; and
the purchasing threshold is only met if the purchasing goal is reached during the specified and limited time period.

15. The method according to claim 11, further comprising:
generating a web page operable to display to the plurality of invitees satisfying the group membership condition the identifier of the recipient and at least one of the purchasing scenario and the purchasing goal.

16. The method according to claim 15, wherein:
the web pages are further operable to display to the plurality of invitees satisfying the group membership condition an indicator of progress toward reaching the purchasing goal.

17. The method according to claim 11, wherein the pooling step further comprises:
computing item selection votes from the plurality of invitees; and
selecting a one of at least two items based on a number of the item-selection votes received from the plurality of individual invitees.

18. The system according to claim 17, wherein:
the item-selection votes are weighted in proportion to at least one of:
an invitee's amount of participation in the purchasing scenario; and
an invitee's time of participation in the purchasing goal relative to at least one other invitee's time of participation in the purchasing goal.

19. The system according to claim 11, further comprising:
receiving from at least one of the plurality of invitees an amendment to the group membership condition.

20. The system according to claim 11, further comprising:
generating a web page operable to display to the plurality of invitees a level of the participation in the purchasing scenario for each invitee within the plurality of invitees.
